(19) United States
(12) Patent Application Publication
(10) Pub. No.: US 2014/0247272 A1
(43) Pub. Date: Sep. 4, 2014

(54) IMAGE PROCESSING APPARATUS, METHOD AND COMPUTER PROGRAM PRODUCT

(71) Applicants: Yoichiro Sako, Tokyo (JP); Akira Tange, Tokyo (JP); Yasuhiro Yamada, Tokyo (JP)

(72) Inventors: Yoichiro Sako, Tokyo (JP); Akira Tange, Tokyo (JP); Yasuhiro Yamada, Tokyo (JP)

(73) Assignee: SONY CORPORATION, Minato-ku, Tokyo (JP)

(21) Appl. No.: 14/346,873

(22) PCT Filed: Sep. 6, 2012
(86) PCT No.: PCT/JP2012/005656

§ 371 Date: Mar. 24, 2014

(30) Foreign Application Priority Data
Oct. 25, 2011 (JP) 2011-233623
Oct. 25, 2011 (JP) 2011-233624

(51) Int. Cl. G06T 11/60; G06T 11/40; G06T 11/00

(52) U.S. Cl. CPC G06T 11/60; G06T 11/001; G06T 11/40
USPC 345/589; 345/636

(57) ABSTRACT

An information processing apparatus, method and computer program product identify a local region of an image, and changes the content of the local region into one of other image data and text. A special process is performed on the local image data of the local region that changes the local image data to different visually recognizable image data. The image data or text is then inserted into the local region of the image.

### TECHNICAL FIELD

The present disclosure relates to an image processing apparatus, method and computer program product.

### BACKGROUND ART

In the near future, processing and editing of a picked-up image acquired by an image pickup apparatus, such as a digital still camera or a video camera, will be extensively used. For example, PTL 1 describes technology which replaces a fixed pattern existing in a background scene with a substitute pattern existing in a foreground scene, when acquiring a composite video image by combining the background and foreground scenes.

Further, PTL 2 discloses a system which modifies advertisement content, such as a signboard of a computer game or a signboard of a sports stadium to be broadcast on television. Further, PTL 3 discloses technology which detects a specific region, such as part of a signboard from a picked-up image, and inserts an image showing, for example, other advertisement content into this specific region.

Further, with the development of information and communications technology, a picked-up image can be easily provided to an unspecified number of people through the internet. Therefore, for the protection of privacy, regions related to privacy in a picked-up image often have a special process, such as a mosaic process or a darkening process, applied to them. Further, a special process applied to an inappropriate image, confidential information, or the like is well known even for content broadcast on television or content recorded to an optical disk. Note that PTL 4 describes, for example, a special process such as a mosaic process or a darkening process.

### CITATION LIST

### Patent Literature

PTL 1: JP H06-510893A
PTL 2: JP 2002-15223A
PTL 3: JP 2008-227813A
PTL 4: JP 2009-194687A

### SUMMARY

### Technical Problem

However, even if privacy information can be protected by a special process such as a mosaic process or a darkening process, since information is lost or deteriorated in a local region to which the special process is applied, visually recognizable information can hardly be obtained from the local region to which the special process is applied. Therefore, a picked-up image to which a special process is applied has a poor efficiency of information transmission.

Accordingly, the present disclosure proposes a new and improved image processing apparatus and program that can improve the efficiency of information transmission by a picked-up image to which a special process is applied.

### Solution to Problem

As a non-limiting example, an image processing apparatus is provided that includes a display controller configured to insert at least one of image data and text into a local region of an image, said local region having local image data and said display controller changes said local image data to different visually recognizable image data created via a special process. A corresponding cloud-based apparatus is also provided, as well as a method and computer program product.

### BRIEF DESCRIPTION OF DRAWINGS

FIG. 1 is an explanatory diagram showing a configuration of the image processing system according to the embodiments of the present disclosure.

FIG. 2 is an explanatory diagram showing a specific example of the picked-up image.

FIG. 3 is a functional block diagram showing a configuration of the portable terminal 20-1 according to a first embodiment.

FIG. 4 is an explanatory diagram showing a specific example of the picked-up image after image processing by the image processing section 252.

FIG. 5 is a flow chart showing the operations of the portable terminal 20-1 according to the first embodiment.

FIG. 6 is a sequence diagram showing a modified example of the first embodiment.

FIG. 7 is a functional block diagram showing a configuration of the portable terminal 20-2 according to a second embodiment.

FIG. 8 is an explanatory diagram showing a specific example of the picked-up image including a local region.

FIG. 9 is an explanatory diagram showing another specific example of the picked-up image including a local region.

FIG. 10 is an explanatory diagram showing another specific example of the picked-up image including local regions.

FIG. 11 is an explanatory diagram showing another specific example of the picked-up image including local regions.

FIG. 12 is an explanatory diagram showing a specific example of the picked-up image after image processing by the image processing section 254.

FIG. 13 is an explanatory diagram showing another specific example of the picked-up image after image processing by the image processing section 254.

FIG. 14 is a flow chart showing the operations of the portable terminal 20-2 according to the second embodiment.

FIG. 15 is an explanatory diagram showing a specific example of the picked-up image into which code information has been inserted.

FIG. 16 is an explanatory diagram showing another specific example of the picked-up image into which code information has been inserted.

FIG. 17 is an explanatory diagram showing a hardware configuration of the portable terminal 20.

### DESCRIPTION OF EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

In this specification and the appended drawings, there may be some cases where structural elements that have substantially the same function and structure are distinguished by denoting a different character or numeral after the same reference numerals. However, in cases where there is there may be no need to particularly distinguish each of the structural elements that have substantially the same function and structure, only the same reference numerals may be denoted.

Further, the present disclosure will be described according to the order of items shown below.

1. Configuration of the image processing system

2. Arrangement of terms

3. The first embodiment

3-1. Background to the first embodiment

3-2. Configuration of the portable terminal according to the first embodiment

3-3. Operations of the portable terminal according to the first embodiment

3-4. Modified example

4. The second embodiment

4-1. Background to the second embodiment

4-2. Configuration of the portable terminal according to the second embodiment

4-3. Operations of the portable terminal according to the second embodiment

5. Supplement to the first and second embodiments

6. Hardware configuration

7. Conclusion

### 1. CONFIGURATION OF THE IMAGE PROCESSING SYSTEM

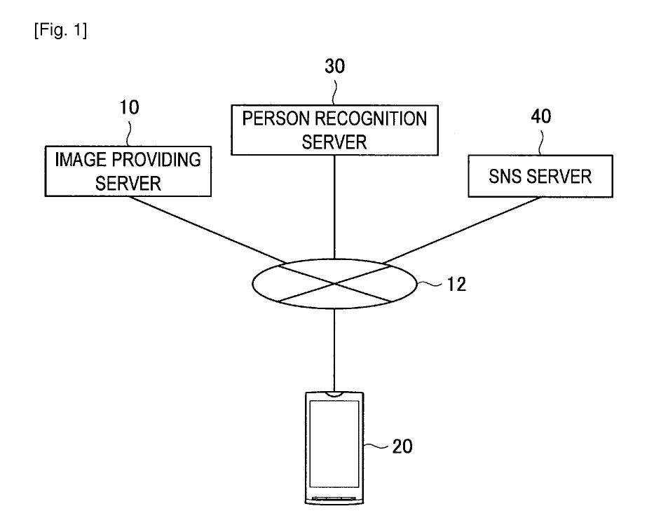

The technology according to the present disclosure may be realized in various forms, such as those described in detail as the examples in <3. The first embodiment>-<5. Supplement to the first and second embodiments>. First, the following will describe, by referring to FIG. 1, a basic configuration of an image processing system common to all embodiments.

FIG. 1 is an explanatory diagram showing a configuration of the image processing system according to the embodiments of the present disclosure. As shown in FIG. 1, the image processing system according to the embodiments of the present disclosure includes an image providing server 10, a portable terminal 20, a person recognition server 30 and an SNS server 40.

The image providing server 10, the portable terminal 20, the person recognition server 30, and the SNS server 40 are connected through a communications network 12, as shown in FIG. 1. Note that the communications network 12 is a cable or wireless transmission line of information transmitted from an apparatus connected to the communications network 12. For example, the communications network 12 may include a public network such as the internet, a telephone network or a satellite communications network, various LAN (Local Area Network) or WAN (Wide Area Network) including Ethernet (registered trademark), or the like. Further, the communications network 12 may include a leased line network of an IP-VPN (Internet Protocol-Virtual Private Network), or the like.

The image providing server 10 provides a picked-up image acquired by an image pickup apparatus. For example, the image providing server 10 may store a picked-up image at multiple points on a map, and may provide the stored picked-up image to the portable terminal 20, in accordance with a request from the portable terminal 20. Or, the image providing server 10 may manage a Web page of an individual or a manufacturer, and may provide the Web page including the picked-up image to the portable terminal 20, in accordance with a request from the portable terminal 20.

The portable terminal 20 is an image processing apparatus which acquires a picked-up image and processes the acquired picked-up image. The portable terminal 20 can also acquire the picked-up image by a variety of techniques. For example, the portable terminal 20 may acquire the picked-up image from the image providing server 10 shown in FIG. 1, may acquire the picked-up image from an image pickup function possessed by the portable terminal 20, or may acquire the picked-up image by reproduction of a recording medium. In addition, the portable terminal 20 may acquire the picked-up image by receiving a broadcast.

Note that while FIG. 1 shows a smart phone as an example of the portable terminal 20, the portable terminal 20 is not limited to a smart phone. For example, the portable terminal 20 may be a cellular phone, a PHS (Personal Handyphone System), a portable music player, a portable video image processing apparatus, a portable gaming device, or the like. In addition, the portable terminal 20 is merely an example of the image processing apparatus according to the present disclosure. The function of the image processing apparatus according to the present disclosure can be realized even by an information processing apparatus, such as a PC (Personal Computer), a household image processing apparatus (such as a DVD recorder or a VCR), a PDA (Personal Digital Assistant), a household gaming device or a household electrical appliance. In addition, the image providing server 10 on the image providing side can function as the image processing apparatus according to the present disclosure.

The person recognition server 30 recognizes who a person is by image analyzing the person's facial image. For example, the person recognition server 30 has a database which stores a facial feature quantity for each person, detects a facial image from a picked-up image by facial pattern matching, analyzes the facial feature quantity of the facial image, and performs person recognition by retrieving a person corresponding to the analyzed feature quantity from the database.

The SNS (Social Networking Service) server 40 provides a service which supports connections between people. For example, the SNS server manages a Web page for each user. A user can establish new interpersonal relationships by publically disclosing their personal information, such as their age, sex, hobbies, hometown and address, or a diary (blog) on their own Web page.

Heretofore, a basic configuration of the image processing system according to the present disclosure has been described. To continue, each embodiment of the present disclosure will be described in detail, after the terms used in the description of the present embodiment have been arranged.

### 2. ARRANGEMENT OF TERMS

Hereinafter, terms used in the description of the present embodiment will be described. However, the contents shown below are merely examples of the meanings of each term, and it should be noted that there may be some cases where meanings different from the contents shown below are used in the present disclosure.

(Privacy/Privacy Region)

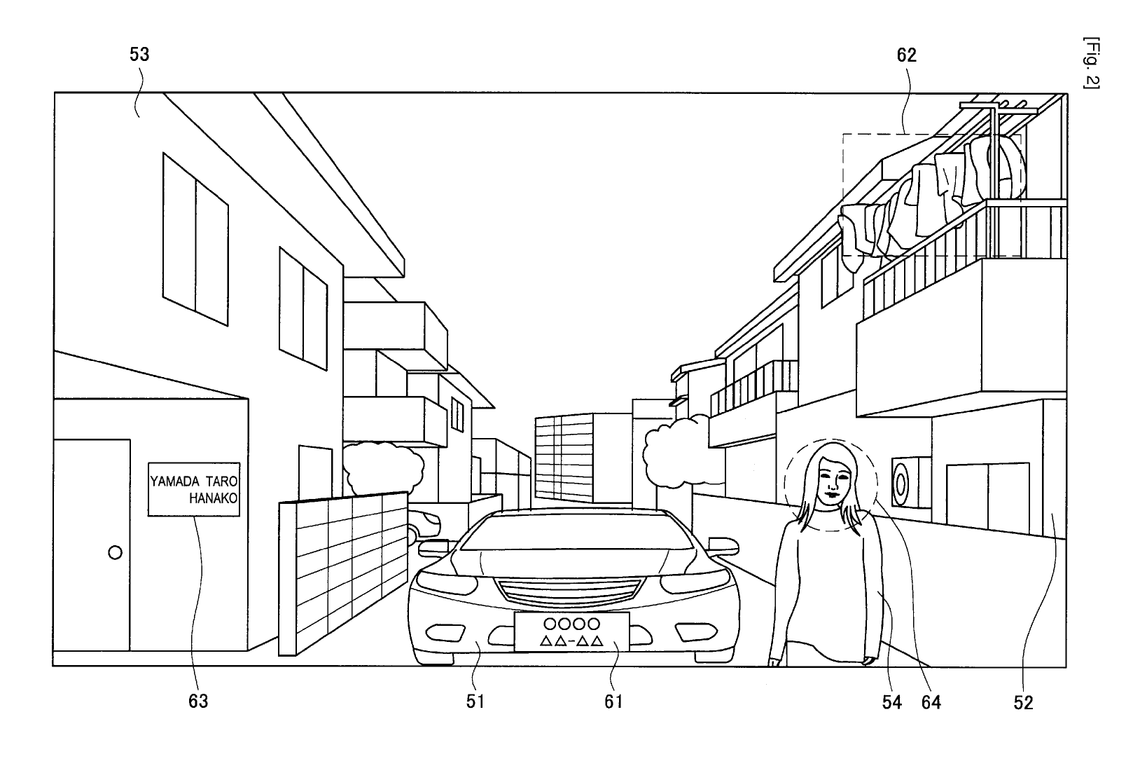

Privacy is a matter related to an individual's private life or to personal matters. Further, a privacy region is a region related to privacy in a picked-up image. Hereinafter, by referring to FIG. 2, privacy and a privacy region are more specifically described.

FIG. 2 is an explanatory diagram showing a specific example of a picked-up image. A vehicle 51, houses 52, 53 and a person 54 are included in the picked-up image, shown in FIG. 2. There are many privacy regions included in this picked-up image at the same time.

For example, since the vehicle 51 is identified by the number plate 61, the picked-up image including the vehicle 51 along with the number plate 61 shows privacy of the user of the vehicle 51 that exists in an image pickup point of the picked-up image. Therefore, since the number plate 61 is a region related to privacy which shows an individual's private life or personal matters, the number plate 61 corresponds to a privacy region. Note that while a 4-wheeled vehicle is shown as the vehicle 51 in FIG. 2, the vehicle 51 may be a motorcycle, a large-sized vehicle, or the like.

Further, as shown in FIG. 2, a picked-up image including the laundry 62 drying on the veranda of the house 52 shows privacy of the clothes worn by the resident of the house 52. Therefore, since the laundry 62 is a region related to privacy which shows an individual's private life or personal matters, the laundry 62 corresponds to a privacy region.

Further, as shown in FIG. 2, the picked-up image including the doorplate 63 of the house 53 shows privacy of the person residing in the house 53, shown by the doorplate 63. Therefore, since the doorplate 63 is a region related to privacy which shows an individual's private life or personal matters, the doorplate 63 corresponds to a privacy region.

Further, since a person may be recognized by their face, as shown in FIG. 2, the picked-up image including a person 54, along with their face 64, shows privacy of the person 54 that exists in an image pickup point of this picked-up image. Therefore, since the face 64 is a region related to privacy which shows an individual's private life or personal matters, the face 64 corresponds to a privacy region.

(Special Process)

A special process is an image process for restricting a visually recognizable information quantity from a local region included in part of a picked-up image. A mosaic process, a shading process, a filling process, or the like are included as examples of a special process. Note that often there are cases where such a special process is applied to a privacy region, such as a person's face or the number plate of a vehicle. Therefore, a local region to which a special process is applied can be treated as a privacy region.

### 3. THE FIRST EMBODIMENT

Heretofore, the terms used in the description of the present embodiment have been described. To continue, a first embodiment of the present disclosure will be described in detail.

### 3-1. Background to the First Embodiment

In the near future, with the development of information and communications technology, a picked-up image will be easily provided to an unspecified number of people through the communications network 12, for example. Therefore, for the protection of privacy, regions related to privacy within the picked-up image often have a special process, such as a mosaic process or a darkening process, applied to them.

However, even if a privacy region can be protected by a special process, such as a mosaic process or a darkening process, since information is lost or deteriorated in the privacy region to which the special process is applied, visually recognizable information can hardly be obtained from the privacy region to which the special process is applied.

Accordingly, the point of view of the above situation led to creating the first embodiment of the present disclosure. According to the first embodiment of the present disclosure, the protection and effective use of privacy regions within a picked-up image can be realized at the same time. Hereinafter, the first embodiment of the present disclosure will be described in detail.

### 3-2. Configuration of the Portable Terminal According to the First Embodiment

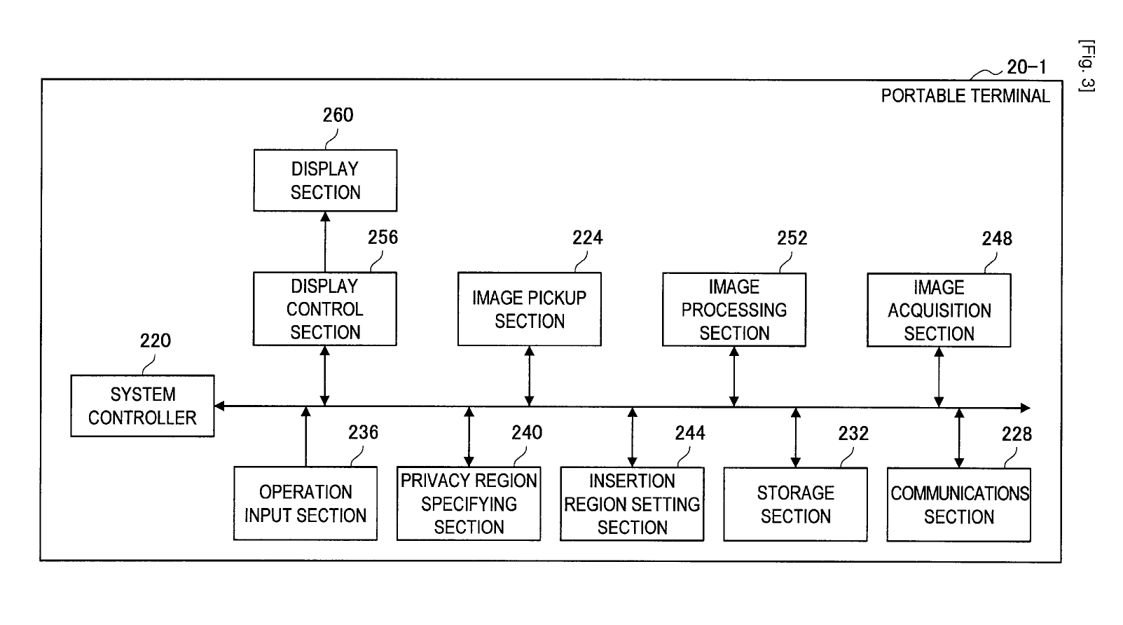

FIG. 3 is a functional block diagram showing a configuration of the portable terminal 20-1 according to the first embodiment. As shown in FIG. 3, the portable terminal 20-1 according to the first embodiment includes a system controller 220, an image pickup section 224, a communications section 228, a storage section 232, an operation input section 236, a privacy region specifying section 240, an insertion region setting section 244, an image acquisition section 248, an image processing section 252, a display control section 256, and a display section 260.

(System Controller)

The system controller 220 includes, for example, a CPU (Central Processing Unit), a ROM (Read Only Memory) and a RAM (Random Access Memory), and controls the overall operation of the portable terminal 20-1. Note that while FIG. 3 shows the functional blocks of the privacy region specifying section 240, the insertion region setting section 244, the image processing section 252, and the display control section 256 separately from the system controller 220, the functions of the privacy region specifying section 240, the insertion region setting section 244, the image processing section 252, and the display control section 256 may be realized by the system controller 220.

(Image Pickup Section)

The image pickup section 224 acquires a picked-up image by imaging a photographic subject. Specifically, the image pickup section 224 includes a photographic optical system such as a photographic lens and a zoom lens, an imaging device such as a CCD (Charge Coupled Device) or a CMOS (Complementary Metal Oxide Semiconductor), and an image pickup signal processing section.

The photographic optical system concentrates light originating from the photographic subject, and forms an image of the photographic subject on an image surface of the imaging device. The imaging device converts the image of the photographic subject formed by the photographic optical system to an electrical image signal. The image pickup signal processing section includes a sample holding/AGC (Automatic Gain Control) circuit which performs gain adjustment and waveform shaping on the image signal obtained by the imaging device, and a video A/D convertor, and obtains a picked-up image as digital data. Further, the image pickup signal processing section performs processes, such as a white balance process, a brightness process, a color signal process, and a blur correction process, on the picked-up image data.

The image pickup section 224, in accordance with the control of the system controller 220, supplies the acquired picked-up image to the communications section 228, the storage section 232, the privacy region specifying section 240, and the display control section 256. Note that the image pickup section 224 includes functions as an image pickup control section which performs the setting of a parameter control and an execution process for each of the processes of an on/off control of an image pickup operation, a zoom lens of the photographic optical system, a control drive of the focus lens, and control of the sensitivity and frame rate of the imaging device.

(Communications Section)

The communications section 228 is an interface with an external device, and communicates by wireless or wires with the external device. For example, the communications section 228 can communicate with the image providing server 10, the person recognition server 30 and the SNS server 40 through the communications network 12. Note that a wireless LAN (Local Area Network) and a LTE (Long Term Evolution), for example, are included as a communications system of the communications section 228.

(Storage Section)

The storage section 232 is used to preserve various data. For example, the storage section 232 preserves a picked-up image that is a processing target according to the present embodiment, an insertion image for inserting into the picked-up image, and an image after processing by the image processing section 252, described later. The storage section 232, in accordance with the control of the system controller 220, performs such things as recording/preserving and reading of various data.

Note that the storage section 232 may be a storage medium, such as a non-volatile memory, a magnetic disk, an optical disk, or an MO (Magneto Optical) disk. For example, a flash memory, an SD card, a micro SD card, a USB memory, an EEPROM (Electrically Erasable Programmable Read-Only Memory), or an EPROM (Erasable Programmable ROM) can be given as the non-volatile memory. Further, a hard disk and magnetic material disk can be given as the magnetic disk. Further, a CD (Compact Disc), a DVD (Digital Versatile Disc) and a BD (Blu-Ray Disc (registered trademark)) can be given as the optical disk.

(Operation Input Section)

The operation input section 236 is a configuration for a user to perform an input operation. The operation input section 236 generates a signal corresponding to a user operation, and supplies the signal to the system controller 220. For example, the operation input section 236 may be a receiver or a receiving section of a wireless signal, designed for an infrared signal generated by an operator or remote controller, such as a touch panel, a button, a switch, a lever, or a dial. In addition, the operation input section 236 may be a sensing device such as an acceleration sensor, an angular velocity sensor, a vibration sensor, or a pressure sensor.

(Privacy Region Specifying Section)

The privacy region specifying section 240 specifies a privacy region from a picked-up image. Note that the picked-up image may be an image acquired by the image pickup section 224, an image read/reproduced from the storage section 232, or an image acquired by the image acquisition section 248 through the communications section 228.

Further, as described in <2. Arrangement of terms>, various targets are considered to be privacy regions. Therefore, the privacy region specifying section 240 specifies the privacy regions by techniques that are different for each of the targets.

For example, the privacy region specifying section 240 may detect a face from a picked-up image by an existing face detection technique which uses face pattern matching, and may specify a region including the detected face as a privacy region.

Further, the privacy region specifying section 240 may detect, within a picked-up image, a rectangular region where a character is included, such as a number plate of a vehicle or a doorplate of a house, and may specify the detected rectangular region as a privacy region. For example, the privacy region specifying section 240 detects, within the picked-up image, such a rectangular region where the outline is a rectangle, trapezoid or parallelogram. In addition, in the case where a rectangular region is detected, the privacy region specifying section 240 judges whether or not a character is included within the rectangular region. Then, in the case where a character is included within the rectangular region, the privacy region specifying section 240 specifies this rectangular region as a privacy region.

Further, the privacy region specifying section 240 may detect, within a picked-up image, a region where drying laundry is included, and may specify the detected region as a privacy region. Here, the clothes of the laundry are not being worn by a person. Further, there are often many lines of clothes of the laundry being dried. Accordingly, the privacy region specifying section 240 may detect the clothes from the picked-up image, where these clothes are not being worn by a person and where clothes adjacent to these clothes exist, and in the case where the adjacent clothes are also not being worn by a person, the privacy region specifying section may specify the region including these clothes as a privacy region.

(Insertion Region Setting Section)

The insertion region setting section 244 sets privacy regions specified by the privacy region specifying section 240 to insertion regions for inserting insertion images, described later. Note that the insertion region setting section 244 may set all or some of the privacy regions to an insertion region.

(Image Acquisition Section)

The image acquisition section 248 acquires images, such as a picked-up image to be subjected to image processing according to the present embodiment and insertion images for inserting into the picked-up image. For example, the image acquisition section 248 may acquire images from the image providing server 10 through the communication section 228, or may acquire images by reproduction/reading from the storage section 232.

(Image Processing Section)

The image processing section 252 inserts insertion images into insertion regions within the picked-up image set by the insertion region setting section 244. Here, the insertion may be a process which overwrites an insertion image onto an image within an insertion region, or may be a process which replaces an image within an insertion region with an insertion image. Further, the insertion images may be images acquired by the image pickup section 224, images read/reproduced from the storage section 232, or images acquired by the image acquisition section 248 through the communications section 228. The image processing section 252 processes such insertion images so as to match the shape and size of the insertion regions, and inserts the insertion images into the insertion regions.

Further, the images used by the image processing section 252 as insertion images may have information different from the images within the insertion regions (privacy regions), or may have relevance to the images within the insertion regions.

For example, in the case where an image within an insertion region is a number plate, the insertion region may include, for example, manufacturer information or vehicle model information of the vehicle, and advertisement information of the manufacturer and products. Further, the insertion image may include link information to a purchase site for vehicle and vehicle-related products, or related parts. In this case, the user can connect the portable terminal 20-1 to the linked destination by selecting the insertion image.

Further, in the case where an image within an insertion region is a doorplate, the insertion image may include, for example, sales information of real estate or advertisement information of a real estate agent or rehousing agent. Further, the insertion image may include link information for the homepage of a real estate purchasing site, or for a real estate agent and rehousing agent.

Further, in the case where an image within an insertion region is laundry, the insertion image may include advertisement information of a dry cleaning shop, or advertisement information of a clothing retailer. Further, the insertion image may include link information to the homepage of the dry cleaning shop and clothing retailer, or to a purchasing site for clothing.

Further, in the case where an image within an insertion region is a person's face, the insertion image may include advertisement information for such things as a beauty salon, glasses or contact lenses.

Further, in the case where an image within an insertion region is a person's face, the insertion image may be information publically disclosed and which relates to this person. For example, in the case where the image within the insertion region is a person's face, the portable terminal 20-1 may request recognition of this person to the person recognition server 30, and may acquire information publically disclosed in the SNS server 40 and which relates to the recognized person. In this case, profile information such as the person's age and sex can be used as the insertion image. Note that in the case where the portable terminal 20-1 has a person recognition function, the portable terminal 20-1 may recognize the person who has his or her face within the insertion region. Moreover, person-specific publically available information is obtained locally or remotely based on an image analysis (person recognition function).

Further, the image processing section 252 may set link information of a Web page, where this person publically discloses a blog, in the insertion image. Since the person included in the picked-up image exists in an image pickup position of the picked-up image, items relating to the surroundings of the image pickup position can be publically disclosed by the blog. For example, in the case where the image pickup position of the picked-up image is a sightseeing spot or a shopping district, impressions and opinions relating to the sightseeing spot or the shopping district may be publically disclosed in the blog. Therefore, the user of the portable terminal 20-1, who wants to know about information of the surroundings of the image pickup position of the picked-up image, can be assisted by setting link information of a Web page, such as that shown above, in the insertion image.

Note that while the above has described advertisement information as an example of the insertion image, in the case where position information showing an image pickup position is set in an image file of the picked-up image, the image processing section 252 may use advertisement information relating to a target surrounding the image pickup position as a preferential insertion image. Or, in the case where the portable terminal 20-1 has a position estimation function, the image processing section 252 may use advertisement information relating to a target surrounding the image pickup position as a preferential insertion image. From such a configuration, an appeal effect of the advertisement information to the user of the portable terminal 20-1 can be increased.

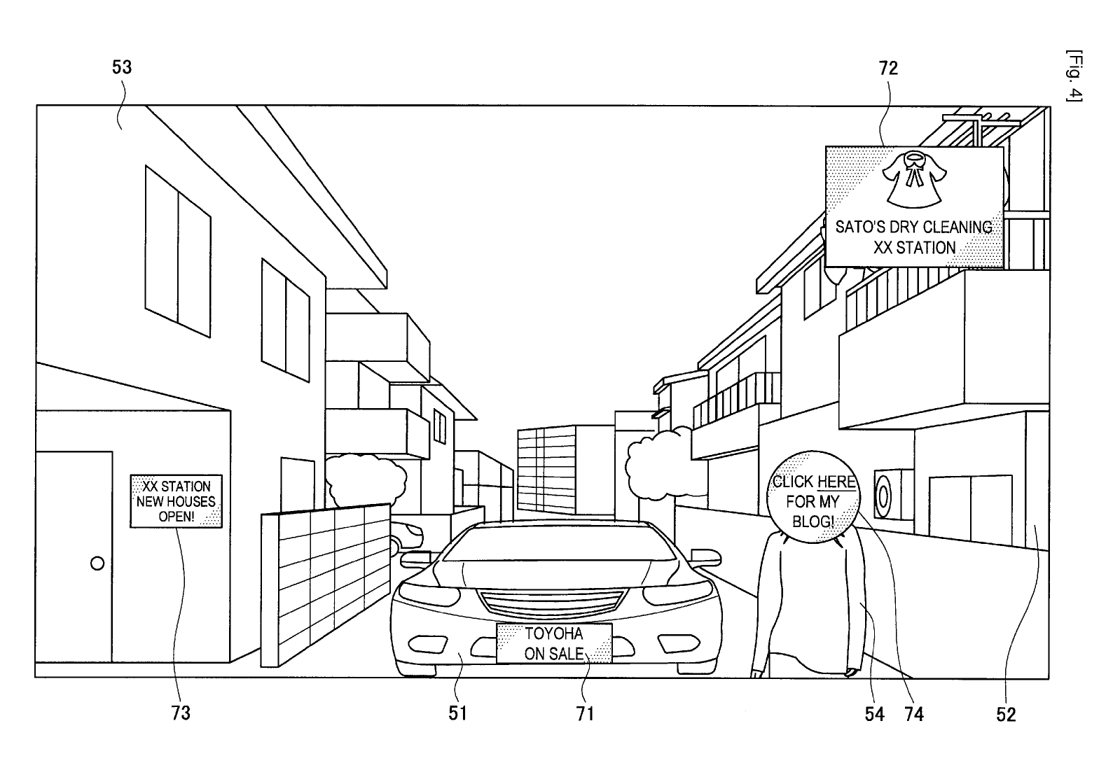

Here, by referring to FIG. 4, a specific example of the picked-up image after image processing by the above described image processing section 252 will be described.

FIG. 4 is an explanatory diagram showing a specific example of the picked-up image after image processing by the image processing section 252. More specifically, FIG. 4 shows a state after image processing by the image processing section 252 of the picked-up image shown in FIG. 2. As shown in FIG. 4, the images within the privacy regions 61-64 included in the picked-up image shown in FIG. 2 are replaced with the insertion images 71-74.

For example, the number plate 61 of the vehicle 51, which is a privacy region, is replaced with the insertion image 71 which includes advertisement information for the manufacturer of the vehicle 51, (TOYOTA on sale) as shown in FIG. 4.

Further, the laundry 62 of the house 52 is replaced with the insertion image 72 which includes advertisement information for a dry cleaning shop, (Sato's dry cleaning, XX station) as shown in FIG. 4. Further, the doorplate 63 of the house 53 is replaced with the insertion image 73 which includes sales information for real estate, (XX station, new houses open!) as shown in FIG. 4.

Further, the face 64 of the person 54 is replaced with the insertion image 74 which includes guidance information to a Web page, (click here for my blog!) as shown in FIG. 4. Note that link information is set in the insertion image 74, and in the case where the insertion image 74 is selected by a user, the portable terminal 20-1 can access the linked Web page. Note that the image processing section 252 may replace the face 64 of the person 54 with a pseudo facial image corresponding to profile information such as age or sex. By such a configuration, the type of person who is inclined to pass through the vicinity of the image pickup position of the picked-up image can be understood from the picked-up image after image processing.

Note that the use of the picked-up image after image processing by the image processing section 252 described above is not particularly limited. For example, the picked-up image after image processing may be displayed on the display section 260, may be held in the storage section 232, or may be transmitted to an external device through the communications section 228.

Further, since promotional efficiency is poor when similar advertisement information is included in the same image, in the case where a plurality of privacy regions (insertion regions) are included in the picked-up image, the image processing section 252 may insert a different insertion image into each of the privacy regions. However, in the case where the number of types of the insertion images is less than the number of privacy regions, the image processing section 252 may insert exceptionally similar insertion images into different privacy regions, and may apply a special process, such as a mosaic process or a darkening process, to some of the privacy regions.

(Display Control Section)

The display control section 256 drives a pixel drive circuit of the display section 260, based on the control of the system controller 220, and displays an image on the display section 260. For example, the display control section 256 may display the picked-up image after image processing by the image processing section 252 on the display section 260. Note that the display control section 256 can perform, for example, a brightness level adjustment, a color correction, a contrast adjustment and a sharpness adjustment (edge enhancement), for image display. Further, the display control section 256 can perform separating and combining of images, for the generation of an expanded image which expands part of the image data, the generation of a compressed image, a soft focus process, a brightness inversion process, a highlight display processes within part of the image (emphasis display), an image effects process such as the change of ambience for all colors, or a piecewise representation of the picked-up image.

(Display Section)

The display section 260 includes a pixel drive circuit, and displays an image by driving the pixel drive circuit according to the control of the display control section 256. Note that the display section may be a liquid crystal display or an organic EL display.

### 3-3. Operations of the Portable Terminal According to the First Embodiment

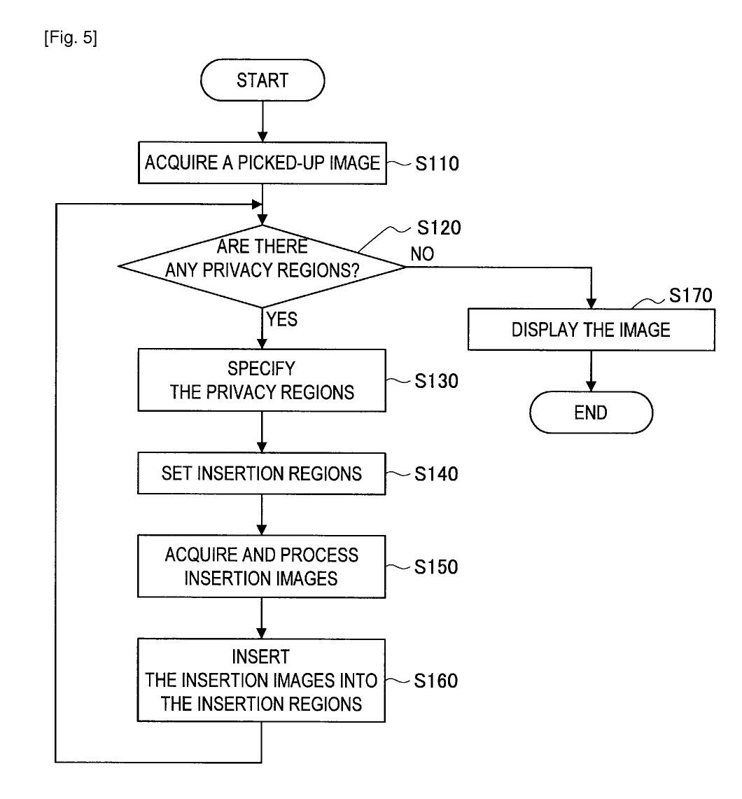

Heretofore, a configuration of the portable terminal 20-1 according to the first embodiment has been described. To continue, by referring to FIG. 5, the operations of the portable terminal 20-1 according to the first embodiment will be described.

FIG. 5 is a flow chart showing the operations of the portable terminal 20-1 according to the first embodiment. First, as shown in FIG. 5, when the portable terminal 20-1 acquires a picked-up image (S110), the privacy region specifying section 240 judges whether or not there are privacy regions within the picked-up image (S120). Note that the portable terminal 20-1 may acquire the picked-up image by the image pickup section 224, by the reading/reproduction of the storage section 232, or through the communications section 228.

Then, in the case where there are privacy regions within the picked-up image, the privacy region specifying section 240 specifies the privacy regions, such as a person's face and a number plate (S130), and the insertion region setting section 244 sets the privacy regions specified by the privacy region specifying section 240 to insertion regions for inserting insertion images (S140).

To continue, the image processing section 252 acquires insertion images related to the images within the insertion regions, and processes the insertion images as necessary (S150). Then, the image processing section 252 inserts the insertion images into the insertion regions set by the insertion region setting section 244, that is, the image processing section 252 replaces the images within the insertion regions with the insertion images (S160).

Afterwards, the portable terminal 20-1 repeats the processes of S130-S160 until no privacy regions are detected from the picked-up image (S120). Then, when no privacy regions are detected from the picked-up image, the display control section 256 displays the picked-up image, in which the privacy regions have been replaced with insertion images by the image processing section 252, on the display section 260 (S170).

Note that while FIG. 5 shows an example of repeating the processes S130-S160 for each privacy region, all privacy regions may be specified first of all, and after performing the processes which relate to all the privacy regions in each step, the next step may be moved onto.

According to the first embodiment of the present disclosure described above, at the same time as protecting privacy regions included in the picked-up images, images including useful information can be inserted into the privacy regions. By such a configuration, the privacy regions within the picked-up image can realize an effective use and improvement of the added value of the images.

### 3-4. Modified Example

Note that while the above has described an example of the portable terminal 20-1 performing specification and image insertion of a privacy region, the processes described above can be realized by cooperation between a plurality of apparatuses. Hereinafter, an example of realizing the processes of the first embodiment by cooperation between the image providing server 10 and the portable terminal 20-1 will be described as a modified example.

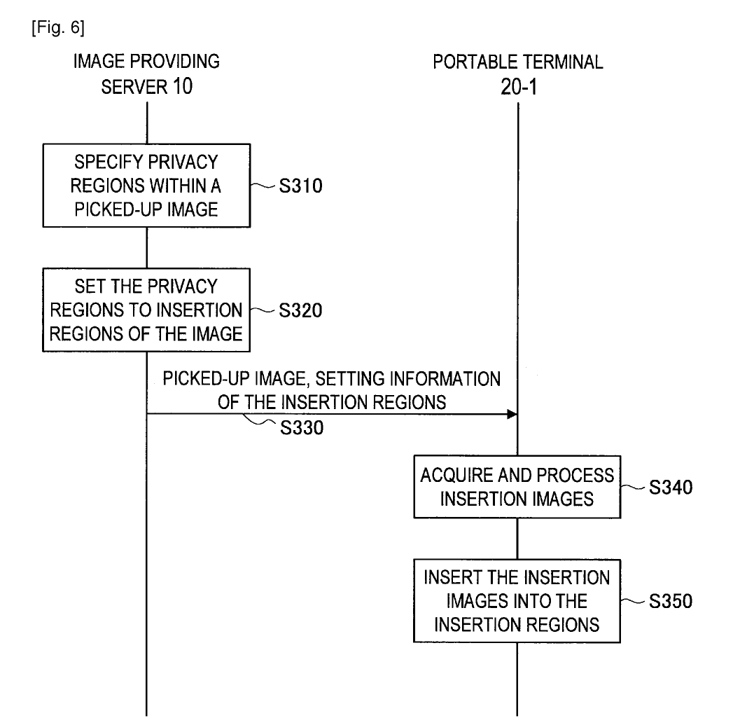

FIG. 6 is a sequence diagram showing a modified example of the first embodiment. In the modified example shown in FIG. 6, the image processing server 10 specifies privacy regions within the picked-up image (S310), and sets the privacy regions to insertion regions of insertion images (S320). Then, the image processing server 10 transmits the picked-up image and the setting information of the insertion regions to the portable terminal 20-1 (S330).

Afterwards, the image acquisition section 248 of the portable terminal 20-1, for example, acquires the insertion images, and the image processing section 252 processes the insertion images as necessary (S340). Then, the image processing section 252 inserts the insertion images into the insertion regions, that is, the image processing section 252 replaces the images within the insertion regions with the insertion images (S350).

Thus, when specifying the privacy regions, insertion of the insertion images can be performed by a different apparatus, and in this case the privacy regions within the picked-up image can realize an effective use and improvement of the added value of the images. While examples have been provided of the local device performing the process, FIG. 1 also shows how the processing may be divided between a local portable apparatus (e.g., terminal 20) and remote devices 10, 30 and 40, any of which may be cloud resources that receive image data from the terminal 20, and provide the special processing and image/text insertion in to local region(s) of the image.

### 4. THE SECOND EMBODIMENT

Heretofore, the first embodiment of the present disclosure has been described. To continue, a second embodiment of the present disclosure will be described.

<4-1. Background to the Second Embodiment>

As described in the background to the first embodiment, in recent times, a special process, such as a mosaic process or a darkening process, is often applied to a privacy region within a picked-up image, for the protection of privacy. Further, a special process applied to an inappropriate image, confidential information, or the like is well known even for content broadcast on television or content recorded to an optical disk.

However, even if privacy information can be protected by a special process such as a mosaic process or a darkening process, since information is lost or deteriorated in a local region to which the special process is applied, visually recognizable information can hardly be obtained from the local region to which the special process is applied. Therefore, a picked-up image to which a special process is applied has a poor efficiency of information transmission.

Accordingly, the point of view of the above situation led to creating the second embodiment of the present disclosure. According to the second embodiment of the present disclosure, the efficiency, added value and convenience of information transmission of the picked-up image to which a special process is applied can be improved. Hereinafter, the second embodiment of the present disclosure will be described in detail.

<4-2. Configuration of the Portable Terminal According to the Second Embodiment>

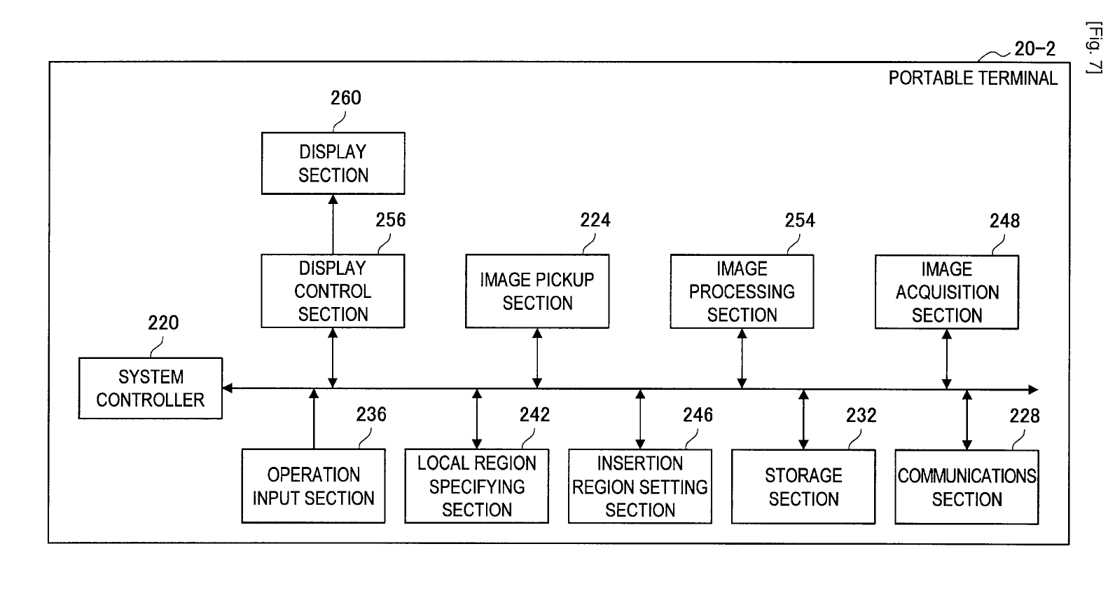

FIG. 7 is a functional block diagram showing a configuration of the portable terminal 20-2 according to the second embodiment. As shown in FIG. 7, the portable terminal 20-2 according to the second embodiment includes a system controller 220, an image pickup section 224, a communications section 228, a storage section 232, an operation input section 236, a privacy region specifying section 242, an insertion region setting section 246, an image acquisition section 248, an image processing section 254, a display control section 256, and a display section 260. Since the configurations of the system controller 220, the image pickup section 224, the communications section 228, the storage section 232, the operation input section 236, the image acquisition section 248, the display control section 256, and the display section 260 are the same as those described in the first embodiment, a detailed description of them will be omitted.

(Local Region Specifying Section)

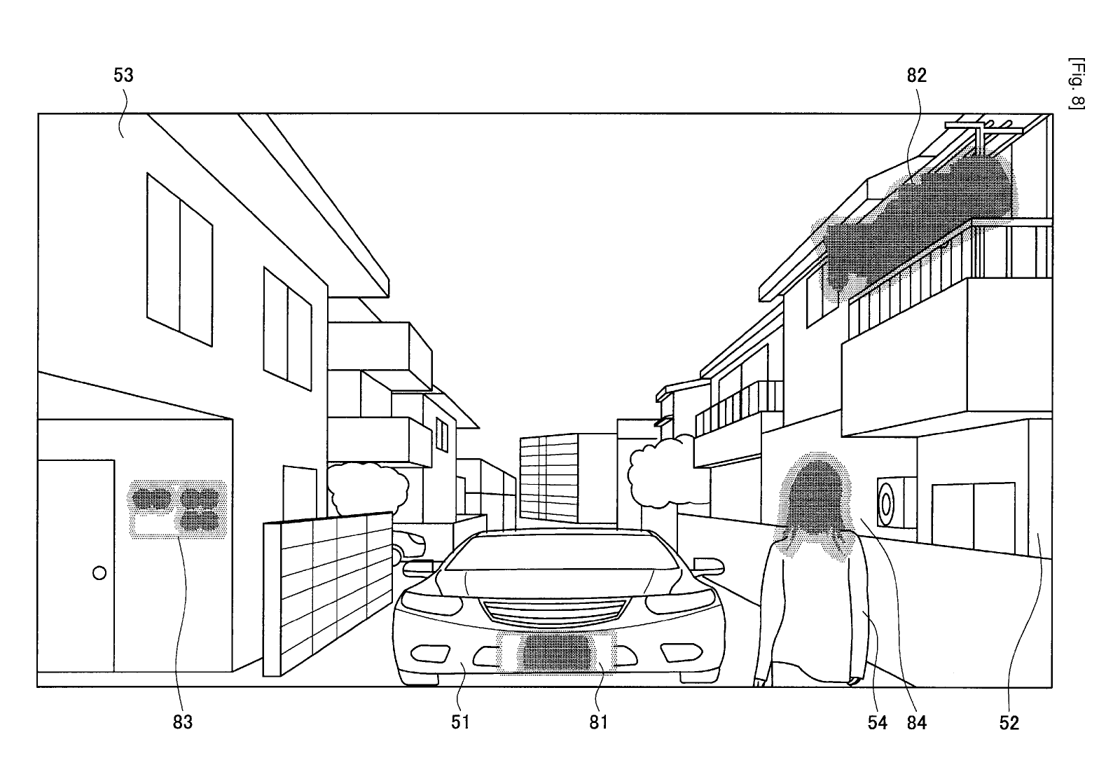

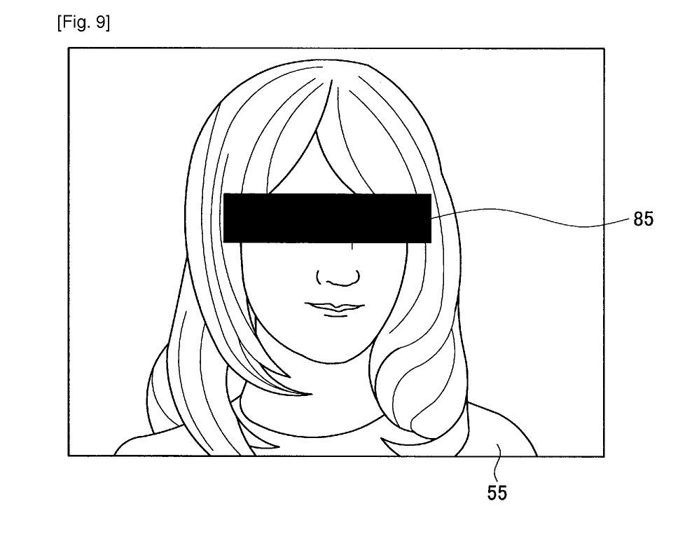

The local region specifying section 242 specifies a local region to which a special process restricting a visually recognizable information quantity is applied. Here, as described in <2. Arrangement of terms>, various image processing processes are considered to be special processes. Therefore, the local region specifying section 242 specifies a local region to which the special process is applied by different techniques in accordance with the type of special process, such as a mosaic process, a shading process or a filling process. Hereinafter, this will be more specially described below, by referring to FIGS. 8 and 9.

FIG. 8 is an explanatory diagram showing a specific example of the picked-up image including local regions. A plurality of local regions 81-84 to which a special process is applied are included in the picked-up image shown in FIG. 8. For example, while the local region 81 corresponds to the region of a number plate of the vehicle 51, since a shading processing is applied, it is difficult to distinguish the content of the number plate. Similarly, for the shading processes applied to the local regions 82-84, it is difficult to distinguish the images before the processes.

The local region specifying section 242 may specify local regions to which such shading processes are applied, by analyzing a frequency element for each of the regions of the picked-up image. For example, since a high frequency element is considered to be low in a region to which the shading process is applied, the local region specifying section 242 may specify a region, where a high frequency element is low compared with the surroundings, as a local region.

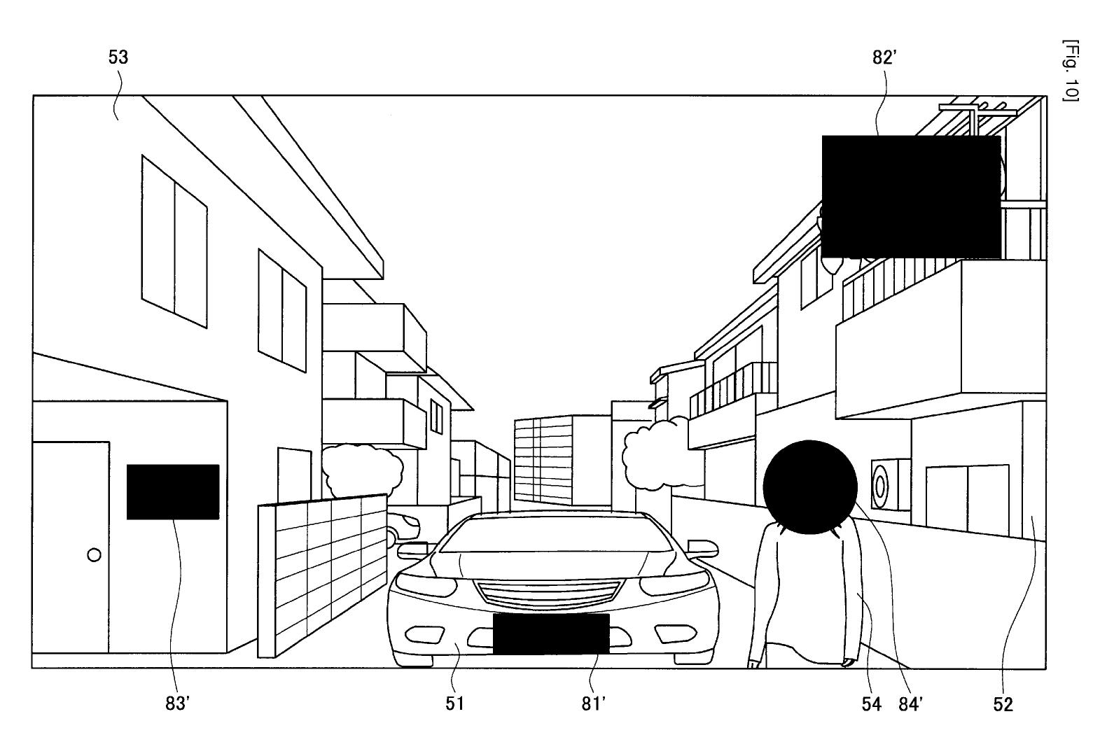

FIG. 9 and FIG. 10 are explanatory diagrams showing another specific example of the picked-up image including local regions. The local region 85 included in the picked-up image shown in FIG. 9 is a region of an eye line of the person 55 to which a filling process is applied. Since an eye line has high identifiability for a person, it is difficult to identify the person 55 from this image in which the eye line has been filled. Similarly, local regions 81′-84′ are included in the picked-up image shown in FIG. 10. Since filling processes are applied to these local regions 81′-84′, it is difficult to visually recognize information, such as an original doorplate or a number plate.

The local region specifying section 242 may specify the local regions to which these kinds of filling processes are applied, by the detection of an edge element of the picked-up image. Further, since a filling process is often applied to a rectangular region, in the case where a shape profile specified by the detection of an edge element is a rectangle, the local region specifying section 242 may specify a region within this rectangle as a local region.

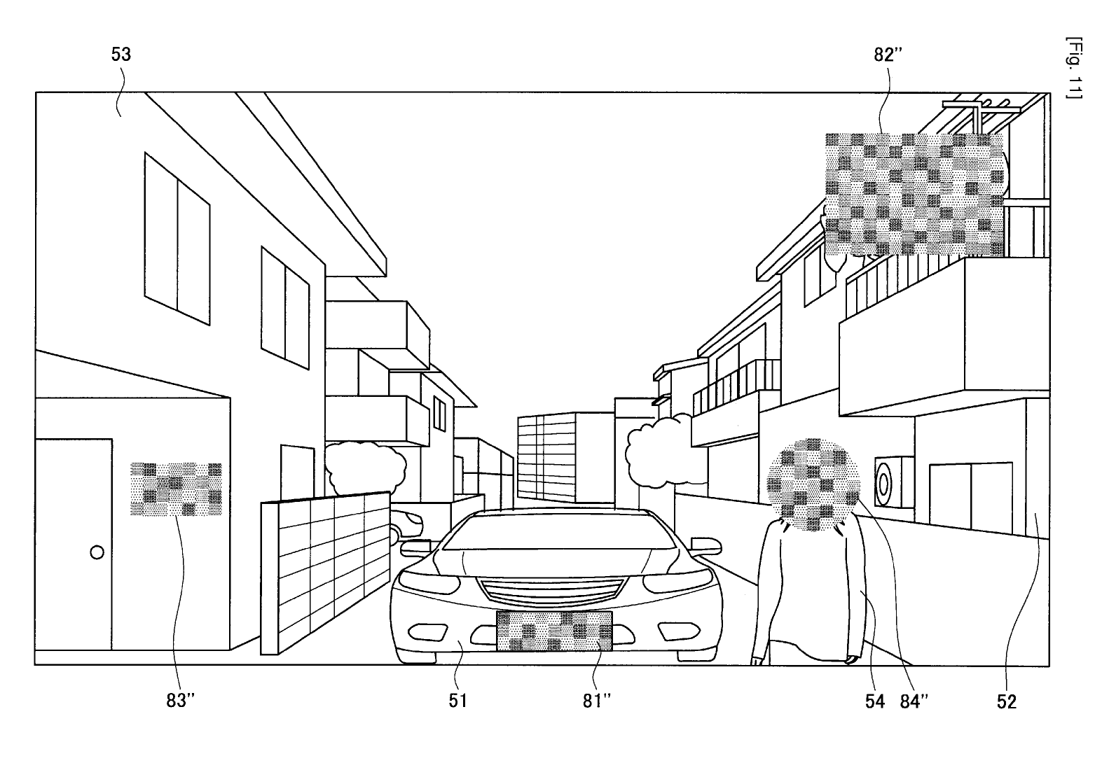

FIG. 11 is an explanatory diagram showing another specific example of the picked-up image including local regions. Local regions 81″-84″ are included in the picked-up image shown in FIG. 11. Since mosaic processes are applied to these local regions 81″-84″, it is difficult to visually recognize information, such as an original doorplate or a number plate. The local regions to which such mosaic processes are applied are sets of pixel blocks, and pixels configuring similar pixel blocks are considered to have the same elements. Accordingly, the local region specifying section 242 may specify a set of pixel blocks having the same elements as a local region.

(Insertion Region Setting Section)

The insertion region setting section 246 sets the local regions specified by the local region specifying section 242 to insertion regions for inserting insertion images, described later. Note that the insertion region setting section 246 may set all or some of the local regions to insertion regions. Also, the insertion of text and/or image data into the local region(s) may be performed as part of the special processor or in addition to the special process.

(Image Processing Section)

The image processing section 254 inserts insertion images into the insertion regions within the picked-up image set by the insertion region setting section 246. Here, the insertion may be a process which overwrites an insertion image onto an image within the insertion region, or may be a process which replaces an image within the insertion region with an insertion image. Further, the insertion images may be images acquired by the image pickup section 224, images read/reproduced from the storage section 232, or images acquired by the image acquisition section 248 through the communications section 228. The image processing section 254 processes such insertion images so as to match the shape and size of the insertion regions, and inserts the insertion images into the insertion regions.

Further, the images used by the image processing section 254 as insertion images may have relevance to the image surroundings of the insertion images (local regions). For example, in the case where the image surroundings is a vehicle, such as the local region 81 shown in FIG. 8, the insertion image may include, for example, manufacturer information or vehicle model information of the vehicle, and advertisement information of the manufacturer and products. Further, the insertion image may include link information to a purchase site for vehicle and vehicle-related products, or related parts. In this case, the user can connect the portable terminal 20-2 to the linked destination by selecting the insertion image.

Further, in the case where the image surroundings is a house, such as the local regions 82 and 83 shown in FIG. 8, the insertion image may include, for example, sales information of real estate or advertisement information of a real estate agent or a rehousing agent. Further, the insertion image may include link information for the homepage of a real estate purchasing site, or for a real estate agent and a rehousing agent. Further, in the case where the image surroundings is a person, such as the local region 84 shown in FIG. 8, the insertion image may include advertisement information for such things as a beauty salon, glasses or contact lenses.

Note that while the above has described advertisement information as an example of the insertion image, in the case where position information which shows an image pickup position is set in the image file of the picked-up image, the image processing section 254 may use advertisement information relating to a target surrounding the image pickup position as a preferential insertion image. Or, in the case where the portable terminal 20-2 has a position estimation function, the image processing section 254 may use advertisement information relating to a target surrounding the current position of the portable terminal 20-2 as a preferential insertion image. From such a configuration, an appeal effect of the advertisement information to the user of the portable terminal 20-2 can be increased.

Further, since promotional efficiency is poor when similar advertisement information is included in the same image, in the case where a plurality of local regions are included in the picked-up image, the image processing section 254 may insert a different insertion image into each of the local regions. However, in the case where the number of types of the insertion images is less than the number of local regions, the image processing section 254 may insert exceptionally similar insertion images into different local regions.

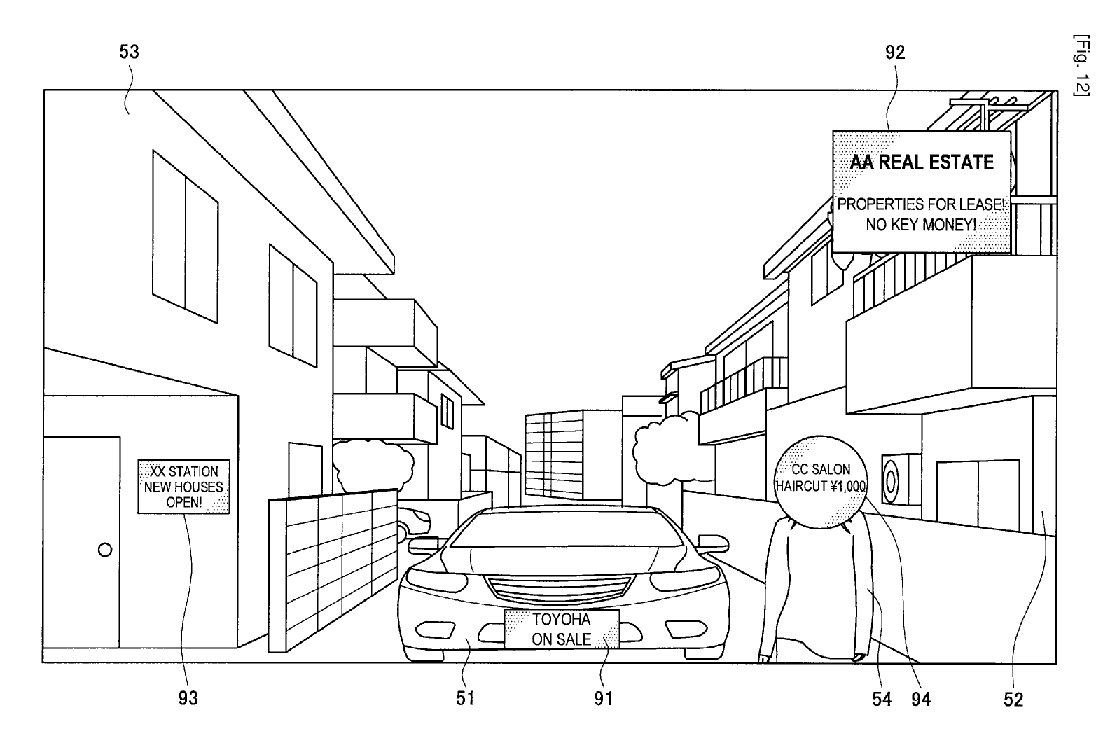

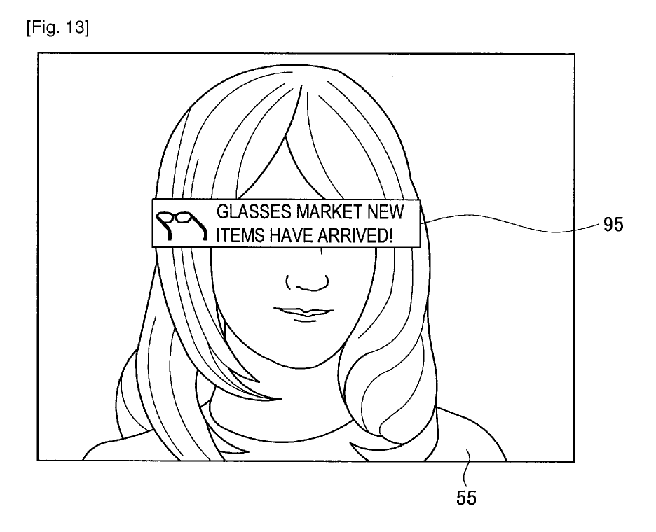

Here, by referring to FIGS. 12 and 13, a specific example of the of the picked-up image after image processing by the above described image processing section 254 will be described.

FIG. 12 is an explanatory diagram showing a specific example of the picked-up image after image processing by the image processing section 254. In more detail, FIG. 12 shows a state after image processing by the image processing section 254 of the picked-up images shown in FIGS. 8, 10 and 11. As shown in FIG. 12, the image processing section 254 replaces images within the local regions 81-84 included in the picked-up images shown in FIG. 8 and the like with the insertion images 91-94. Note that while FIG. 10 shows an example of replacing images within the local regions with insertion images, the image processing section 254 may insert insertion images into the insertion regions by an attached shape. That is, the image processing section 254 may not necessarily extract an original image within a local region.

FIG. 13 is an explanatory diagram showing another specific example of the picked-up image after image processing by the image processing section 254. In more detail, FIG. 13 shows a state after image processing by the image processing section 254 of the picked-up image shown in FIG. 9. As shown in FIG. 13, the image processing section 254 can insert the insertion image 95 into the insertion region 85 to which a filling process is applied.

<4-3. Operations of the Portable Terminal According to the Second Embodiment>

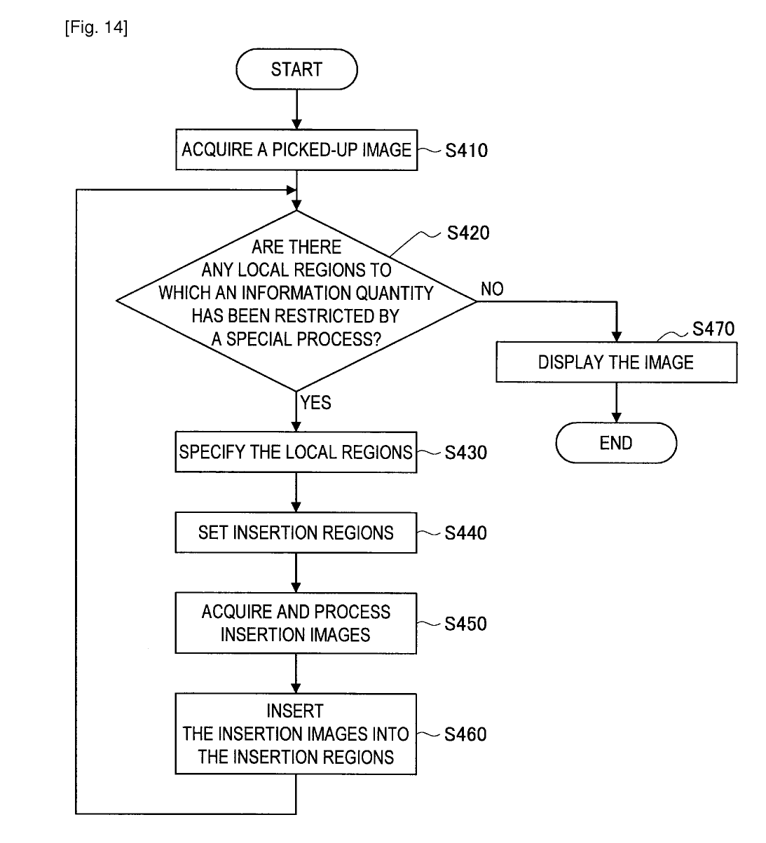

Heretofore, a configuration of the portable terminal 20-2 according to the second embodiment has been described. To continue, by referring to FIG. 14, the operations of the portable terminal 20-2 according to the second embodiment will be described.

FIG. 14 is a flow chart showing the operations of the portable terminal 20-2 according to the second embodiment. First, as shown in FIG. 14, when the portable terminal 20-2 acquires a picked-up image (S410), the local region specifying section 242 judges whether or not there are local regions, to which an information quantity has been restricted by a special process, within the picked-up image (S420). Note that the portable terminal 20-2 may acquire the picked-up image by the image pickup section 224, by reading/reproduction of the storage section 232, or through the communications section 228.

Then, in the case where there are local regions within the picked-up image, the local region specifying section 242 specifies the local regions to which a special process, such as a shading process or a filling process, is applied (S430), and the insertion region setting section 246 sets the local regions specified by the local region specifying section 242 to insertion regions for inserting insertion images (S440).

To continue, the image processing section 254 acquires insertion images related to the images within the insertion regions, and processes the insertion images as necessary (S450). Then, the image processing section 254 inserts the insertion images into the insertion regions set by the insertion region setting section 246, that is, the image processing section 254 replaces the images within the insertion regions with the insertion images (S460).

Afterwards, the portable terminal 20-2 repeats the processes of S430-S460 until no local regions are detected from the picked-up image (S420). Then, when no local regions are detected from the picked-up image, the display control section 256 displays the picked-up image, in which insertion images have been inserted into the local regions by the image processing section 254, on the display section 260 (S470).

Note that while FIG. 14 shows an example of repeating the processes S430-S460 for each local region, all local regions may be specified first of all, and after performing the processes which relate to all the local regions in each step, the next step may be moved onto. Further, as described as the modified example in the first embodiment, the processes described above can be realized by cooperation between a plurality of apparatuses (for example, the portable terminal 20-2 and the image providing server 10).

Further, the use of the picked-up image after image processing by the image processing section 254 described above is not particularly limited. For example, the picked-up image after image processing may be displayed on the display section 260, may be held in the storage section 232, or may be transmitted to an external device through the communications section 228.

According to the second embodiment of the present disclosure described above, images including useful information can be inserted into the local regions to which a special process, such as a shading process or a filling process, is applied. By such a configuration, efficiency, added value and convenience of information transmission of the picked-up image to which a special process is applied can be improved.

### 5. SUPPLEMENT TO THE FIRST AND SECOND EMBODIMENTS

While the above has described examples of the image processing sections 252 and 254 (hereinafter, simply called the image processing section) inserting insertion images, such as advertisement information, into insertion regions of privacy regions or local regions, the insertion images are not limited to the examples described above. For example, the insertion images may be code information, such as an ISBN code, a POS code, a URL, a URI (Uniform Resource Identifier), an IRI (Internationalized Resource Identifier), a QR code, or a cyber-code. Hereinafter, these points will be more specifically described.

When insertion regions of privacy regions or local regions are set, the image processing section decides on the code information inserted from the shape and size of the insertion regions, and the arrangement of the code information, and inserts bar code information into the insertion regions.

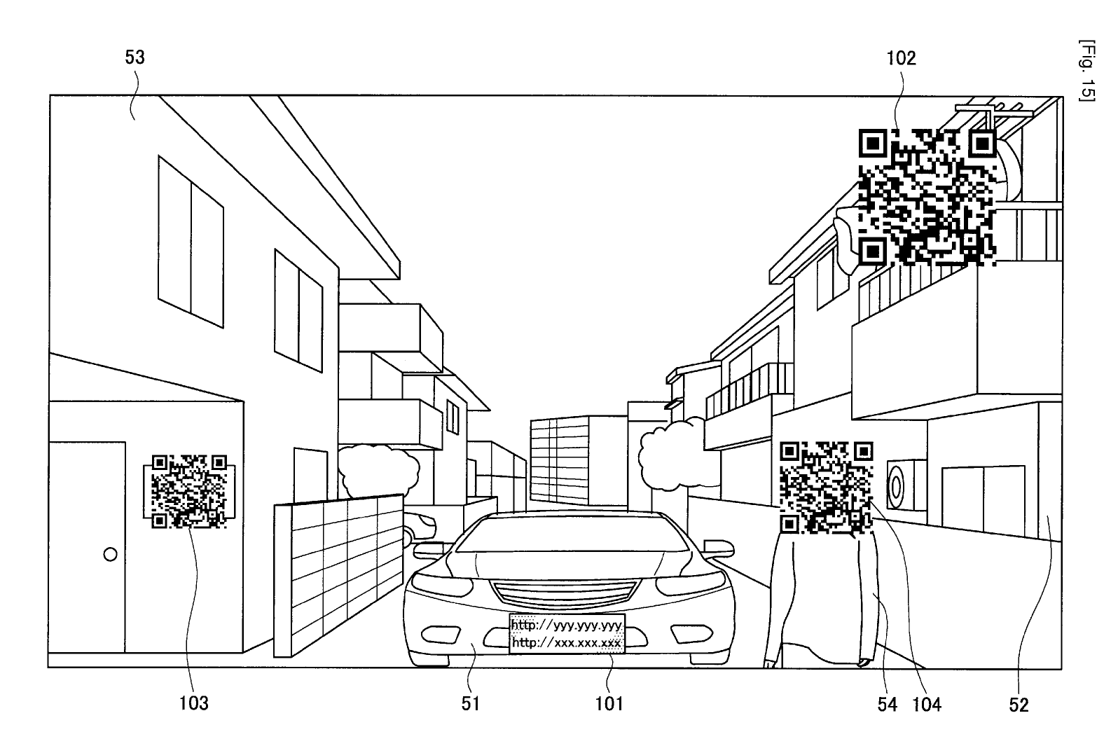

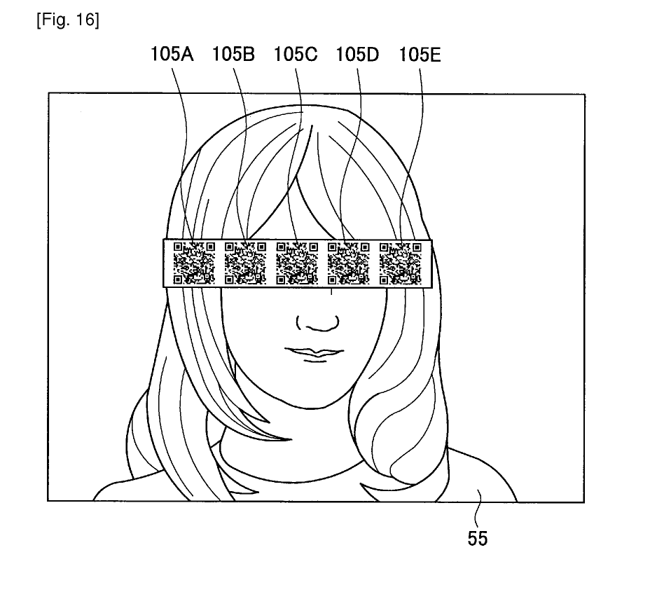

FIGS. 15 and 16 are explanatory diagrams showing specific examples of the picked-up image in which code information has been inserted. As shown in FIG. 15, the image processing section may insert QR code 102-104 into insertion regions, such as privacy regions or local regions, and may insert a URL 101. Further, the image processing section may insert 2 lines of the URL 101 into the insertion region within the vehicle 51 shown in FIG. 15, since the insertion region within the vehicle 51 is a horizontally long shape. Further, as shown in FIG. 16, the image processing section may decide on an arrangement where 5 QR codes are aligned, from the shape of an eye line region that is the insertion region within the person 55, and may insert QR code 105A-105E into the insertion region within the person 55.

Note that while the above has described an example of the insertion regions as privacy regions or local regions, the insertion regions are not limited to such examples. For example, the insertion regions may be regions specified personally. Further, the code information may be encryption key information, and in the case where the encryption key information has been decrypted, an original image may be reproduced by the code information that has been deleted. Further, the code information may be watermark information, such as copyright management information. Further, the code information inserted into the insertion regions may have relevance to the insertion regions or the image surroundings of the insertion regions.

As described above, added value of the images and convenience can be increased by inserting code information into the insertion regions. Further, while the insertion image set by the link information of the insertion image 74 shown in FIG. 4 may not need to be used when an image is printed, a two dimensional bar code, such as a QR code or a cyber-code, is useful for the point that it can be used when an image is printed.

### 6. HARDWARE CONFIGURATION

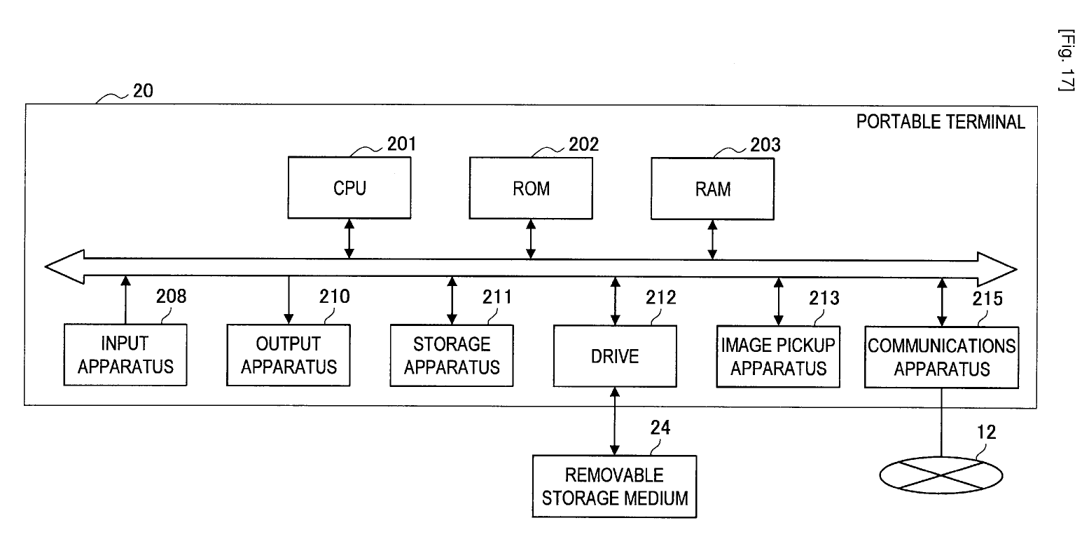

Image processing by the portable terminal 20 described above is realized by cooperation between hardware possessed by the portable terminal 20, and is hereinafter described by referring to FIG. 17.

FIG. 17 is an explanatory diagram showing a hardware configuration of the portable terminal 20. As shown in FIG. 17, the portable terminal 20 includes a CPU (Central Processing Unit) 201, a ROM (Read Only Memory) 202, a RAM (Random Access Memory) 203, an input apparatus 208, an output apparatus 210, a storage apparatus 211, a drive 212, an image pickup apparatus 213, and a communications apparatus 215.

The CPU 201 functions as an operation processing apparatus and a control apparatus, and controls all operations within the portable terminal 20, in accordance with various programs. Further, the CPU 201 may be a microprocessor. The ROM 202 stores programs and operation parameters used by the CPU 201. The RAM 203 temporarily stores programs used in the execution of the CPU 201, and parameters which arbitrary change in these executions. These sections are mutually connected by a host bus configured from a CPU bus or the like.

The input apparatus 208 includes an input section, such as a mouse, a keyboard, a touch panel, a button, a microphone, a switch, or a leaver, for a user to input information, and an input control circuit which generates an input signal based on an input by the user, and outputs an input signal to the CPU 201. The user of the portable terminal 20 can input various data for the portable terminal 20 by operating the input apparatus 208, and can display the process operations. Note that this input apparatus corresponds to the operation input section 236 shown in FIGS. 3 and 7.

The output apparatus 210 includes, for example, a display device such as a liquid crystal display (LCD) apparatus, an OLED (Organic Light Emitting Diode) apparatus, or a lamp. In addition, the output apparatus 210 includes a voice output apparatus such as a speaker or headphones. For example, the display apparatus displays a picked-up image and a generated image. On the other hand, the voice output apparatus converts voice data and outputs a voice.

The storage apparatus 211 is an apparatus for data storage configured as an example of a storage section of the portable terminal 20, such as in the present embodiment. The storage apparatus 211 may include a storage medium, a recording apparatus which records data to the storage medium, and an erasure apparatus which erases data recorded in a reading apparatus reading from the storage medium, and the storage medium. The storage apparatus 211 stores the programs executed by the CPU 201 and various data. Note that the storage medium 211 corresponds to the storage section 232 shown in FIGS. 3 and 7.

The drive 212 is a reader/writer for the storage medium, and is built into the portable terminal 20 or is externally attached. The drive 212 reads out information recorded in a removable storage medium 24, such as a mounted magnetic disk, an optical disk, a magneto-optical disk, or a semiconductor memory, and outputs the information to the RAM 203. Further, the drive 212 can write information to the removable storage medium 24.

The image pickup apparatus 213 includes an image pickup optical system, such as a photographic lens which converges light and a zoom lens, and a signal conversion element such as a CCD (Charge Coupled Device) or a CMOS (Complementary Metal Oxide Semiconductor). The image pickup system forms a photographic subject in a signal conversion section by converging the light originating from the photographic subject, and the signal conversion element converts the formed photographic subject into an electrical image signal. Note that the image pickup apparatus 213 corresponds to the image pickup section 234 shown in FIGS. 3 and 7.

The communications apparatus 215 is, for example, a communications interface configured by a communications device for connecting to the communications network 12. Further, even if the communications apparatus 215 is a communications apparatus adaptive to wireless LAN (Local Area Network) or LTE (Long Term Evolution), the communications apparatus 215 may be a wire communications apparatus which communicates by cables. Note that the communications apparatus 215 corresponds to the communications section 228 shown in FIGS. 3 and 7.

### 7. CONCLUSION

According to the first embodiment of the present disclosure described above, at the same time as protecting privacy regions included in the picked-up image, images including useful information can be inserted into the privacy regions. By such a configuration, the privacy regions within the picked-up image can realize an effective use and improvement of the added value of the images.

Further, according to the second embodiment of the present disclosure, images including useful information can be inserted into regions to which a special process, such as a shading process or a filling process, is applied. By such a configuration, efficiency, added value and convenience of information transmission of the picked-up image to which the special process is applied can be improved.

It should be understood by those skilled in the art that various modifications, combinations, sub-combinations and alterations may occur depending on design requirements and other factors insofar as they are within the scope of the appended claims or the equivalents thereof.

For example, each step in the processes of the portable terminal 20 in the present specification may not necessarily be processed in the time series according to the order described as a sequence diagram or a flow chart. For example, each step in the processes of the portable terminal 20 may be processed in parallel, even if each step in the processes of the portable terminal 20 is processed in an order different than that of the order described as a flowchart.

Further, a computer program for causing hardware, such as the CPU 201, the ROM 202 and the RAM 203 built-into the portable terminal 20, to exhibit functions similar to each configuration of the above described portable terminal 20 can be created. Further, a storage medium storing this computer program can also be provided.

Additionally, the present technology may also be configured as below.

According to an image processing apparatus embodiment, the apparatus includes

a display controller configured to insert at least one of image data and text into a local region of an image, said local region having local image data and said display controller changes said local image data to different visually recognizable image data created via a special process.

According to one aspect of the embodiment, the display controller inserts image data into the local region of the image

According to another aspect of the embodiment, the display controller inserts text data into the local region of the image

According to another aspect of the embodiment, the apparatus further includes an image processing section that executes the special process, said special process being a mosaic process.

According to another aspect of the embodiment, the apparatus further includes an image processing section that executes the special process, said special process being a shading process.

According to another aspect of the embodiment, the apparatus further includes an image processing section that executes the special process, said special process being a filling process.

According to another aspect of the embodiment, the display controller recognizes said local region as a privacy region.

According to another aspect of the embodiment, the display controller inserts image data of an image into the local region, said image being relevant with imagery that surrounds said local region.

According to another aspect of the embodiment, the apparatus further includes an image pickup section that identifies the local region of said image and a different local region of said image, wherein

the display controller inserts image data in the local region, and different image data in said different local region.

According to another aspect of the embodiment, the display controller inserts a commercial image into the local region.

According to another aspect of the embodiment, the display controller inserts text information into the local region, said text information including network access information.

According to another aspect of the embodiment, the special process inserts the at least one of image data and text into the local region of the image as part of the special process.

According to another aspect of the embodiment, the apparatus further includes an image acquisition section that acquires person-specific publically available information based on an image analysis of the local region, wherein

the local region is a facial region specified as a privacy region, and

the display controller inserts said person-specific publically available information in said privacy region.

According to another aspect of the embodiment, the apparatus further includes a communication section that exchanges information with external devices, wherein

said communication section receives image data from a remote device, and said display controller inserts said image data from the remote device.

According to another aspect of the embodiment, the apparatus further includes a communication section that exchanges information with an external image providing device, wherein

said communication section receives image data from the external image providing device, and said display controller inserts said image data from the external image providing device.

According to another aspect of the embodiment, the apparatus further includes a communication section that exchanges information with an external text server device, wherein

said communication section receives text data from the external text server device, and

said display controller inserts said image data from the external text server device.

According to another aspect of the embodiment, the apparatus further includes a communication section that exchanges information with an external person recognition device, wherein

said communication section provides image data from said local region to said external person recognition device, and receives person-specific text or image data from the external person recognition device, and

said display controller inserts said text or image data from the external person recognition device.

According to another information processing apparatus embodiment, the apparatus includes

a communications interface that exchanges information with a remote portable device; and

a processor that receives an image from the remote portable device and identifies a local region in the image, said processor being configured to insert at least one of image data and text into the local region of an image, said local region having local image data and said processor changes said local image data to different visually recognizable image data by executing a special process.

According to one aspect of the embodiment, the processor is configured to execute the special process, said special process being one of a mosaic process, a shading process, and a filling process.

According to another aspect of the embodiment, the processor sets the local region as a privacy region.

According to another aspect of the embodiment, the processor inserts image data of an image into the local region, said image being relevant with imagery that surrounds said local region.

According to another aspect of the embodiment, the processor inserts a commercial image of an image into the local region.

According to another aspect of the embodiment, the processor inserts text information into the local region, said text information including network access information.

According to an information processing method embodiment, the method includes identifying with a processing circuit a local region of an image; and

executing a special process on local image data of the local region that changes the local image data to different visually recognizable image data; and inserting at least one of image data and text into the local region of the image.

According to a non-transitory computer readable medium embodiment, the medium has computer readable instructions stored thereon that when executed by a processing circuit perform a method, the method includes

identifying with a processing circuit a local region of an image; and

executing a special process on local image data of the local region that changes the local image data to different visually recognizable image data; and

inserting at least one of image data and text into the local region of the image.

### REFERENCE SIGNS LIST

10 Image providing server
12 Communications network
20 Portable terminal
30 Person recognition server
40 SNS server
220 System controller
224 Image pickup section
228 Communications section
232 Storage section
234 Image pickup section
236 Operation input section
240 Privacy region specifying section
242 Local region specifying section
244, 246 Insertion region setting section
248 Image acquisition section
252, 254 Image processing section
256 Display control section
260 Display section

1. An image processing apparatus comprising:
a display controller configured to insert at least one of image data and text into a local region of an image, said local region having local image data and said display controller changes said local image data to different visually recognizable image data created via a special process.

2. The image processing apparatus of claim 1, wherein:
the display controller inserts image data into the local region of the image

3. The image processing apparatus of claim 1, wherein:
the display controller inserts text data into the local region of the image

4. The image processing apparatus of claim 1, further comprising:
an image processing section that executes the special process, said special process being one of a mosaic process a shading process, and a filling process.

5. The image processing apparatus of claim 1, wherein:
the display controller recognizes said local region as a privacy region.

6. The image processing apparatus of claim 1, wherein:
the display controller inserts image data of an image into the local region, said image being relevant with imagery that surrounds said local region.

7. The image processing apparatus of claim 1, further comprising:
an image pickup section that identifies the local region of said image and a different local region of said image, wherein
the display controller inserts image data in the local region, and different image data in said different local region.

8. The image processing apparatus of claim 1, wherein:
the display controller inserts a commercial image into the local region.

9. The image processing apparatus of claim 1, wherein:
the display controller inserts text information into the local region, said text information including network access information.

10. The image processing apparatus of claim 1, wherein:
wherein the special process inserts the at least one of image data and text into the local region of the image as part of the special process.

11. The image processing apparatus of claim 1, further comprising:
an image acquisition section that acquires person-specific publically available information based on an image analysis of the local region, wherein
the local region is a facial region specified as a privacy region, and
the display controller inserts said person-specific publically available information in said privacy region.

12. The image processing apparatus of claim 1, further comprising:
a communication section that exchanges information with external devices, wherein
said communication section receives image data from a remote device, and said display controller inserts said image data from the remote device.

13. The image processing apparatus of claim 1, further comprising:
a communication section that exchanges information with an external person recognition device, wherein
said communication section provides image data from said local region to said external person recognition device, and receives person-specific text or image data from the external person recognition device, and said display controller inserts said text or image data from the external person recognition device.

14. An information processing device comprising:
a communications interface that exchanges information with a remote portable device; and
a processor that receives an image from the remote portable device and identifies a local region in the image, said processor being configured to insert at least one of image data and text into the local region of an image, said local region having local image data and said processor changes said local image data to different visually recognizable image data by executing a special process.

15. The information processing apparatus of claim 14, wherein
said processor is configured to execute the special process, said special process being one of a mosaic process, a shading process, and a filling process.

16. The information processing device of claim 14, wherein
the processor sets the local region as a privacy region.

17. The information processing apparatus of claim 14, wherein
the processor inserts image data of an image into the local region, said image being relevant with imagery that surrounds said local region.

18. The information processing apparatus of claim 14, wherein
the processor inserts a commercial image of an image into the local region.

19. The information processing apparatus of claim 14, wherein
the processor inserts text information into the local region, said text information including network access information.

20. An information processing method comprising:
identifying with a processing circuit a local region of an image; and
executing a special process on local image data of the local region that changes the local image data to different visually recognizable image data; and
inserting at least one of image data and text into the local region of the image.
